(19) United States
(12) Patent Application Publication
(10) Pub. No.: US 2010/0208671 A1
(43) Pub. Date: Aug. 19, 2010

(54) COMMUNICATION SYSTEM, USER EQUIPMENT REGISTRATION METHOD, SWITCHING DEVICE AND USER EQUIPMENT REGISTRATION SYSTEM

(75) Inventors: Toshiyuki Tamura, Tokyo (JP); Andreas Kunz, Heidelberg (DE)

Correspondence Address: YOUNG & THOMPSON, 209 Madison Street, Suite 500, Alexandria, VA, 22314, US

(73) Assignee: NEC CORPORATION, Tokyo (JP)

(21) Appl. No.: 12/669,914

(22) PCT Filed: Jul. 10, 2008
(86) PCT No.: PCT/JP2008/062871

§ 371 Date: Jan. 20, 2010

(30) Foreign Application Priority Data
Jul. 27, 2007 (JP) 2007-196735

(51) Int. Cl. H04W 8/02; H04W 8/00

(52) U.S. Cl. 370/329; 370/328

(57) ABSTRACT

A communication system that integrates a multimedia service using an internet protocol, and allows for access via a circuit switched domain, including a serving call session controller, circuit switched access adaptation element, and controller selecting element. The serving call session controller controls a call session by a registered user equipment. The circuit switched access adaptation element adds relevant information related to a location of the user equipment to a registration request of the user equipment connected to the circuit switched domain. The controller selecting element determines a serving call session controller for registering the user equipment based on the relevant information added to the registration request by the circuit switched access adaptation element.

### TECHNICAL FIELD

The present invention relates to a mobile communication system.

### BACKGROUND ART

### Introduction

The IP Multimedia Subsystem (IMS) principles in 3GPP TS 23.228 only allow selecting a Serving Call Session Control Function (S-CSCF) in the home network, i.e. the service control for Home subscribed services for a roaming subscriber is in the Home network. The S-CSCF selection is done in the Home Subscriber Server (HSS) as a response from the Interrogating CSCF (I-CSCF) along with an IMS registration request of the subscriber.

In some cases it would also be beneficial to select the S-CSCF geographically that is close to the subscriber. This would be the case e.g. for emergency calls or for some of the services of IMS Centralized Services (ICS).

While current CS (Circuit Switched) domain services are provided in the visited MSC (Mobile Switching Center) using the replicated subscriber data that is copied from the HLR (Home Location Resister), the IMS services are always provided by the S-CSCF in the user's home network by using a downloaded user profile from the HSS. The S-CSCF then provides services through interaction with a service platform based on this user profile. Since a visited MSC is tightly coupled with the subscriber's location, it can provide local dialing services in the same manner as a local switching system in fixed telephony. On the other hand, an S-CSCF cannot provide local dialing service by itself since the S-CSCF is assigned to a subscriber regardless of his location.

If the S-CSCF can be chosen based on the subscriber's location, IMS localized services like Emergency call, regional advertisements, regional event announcements, etc could be possible.

### <<Various IMS Registration Scenarios >>

### <Typical IMS Registration Scenario>

FIG. 1 shows the typical IMS registration scenario:

The UE sends a REGISTER to the P(Proxy)-CSCF in order to register with IMS. The P-CSCF forwards the message to the I-CSCF in the home network and the I-CSCF queries the HSS for the S-CSCF address. Then the I-CSCF can forward the REGISTER to the S-CSCF, which then requests the user profile from the HSS and acknowledges the successful registration by sending a 200 OK.

### <Emergency IMS Registration Scenario>

3GPP TS 23.167 defines the emergency session control in the IMS. FIG. 2 shows an emergency IMS registration scenario. It is assumed here that the Emergency-CSCF (E-CSCF) is collocated with the normal S-CSCF as the typical implementation option.

The E-CSCF has an interface with the Location Retrieval Function (LRF) as the additional function to the S-CSCF. The LRF is responsible for retrieving the location information of the UE that has initiated an IMS emergency session. It shall be possible to support configurations where the Location Retrieval Function (LRF) may consist of a Routing Determination Function (RDF) and a Location Server (e.g. GMLC (Gateway Mobile Location Center)).

In this case the P-CSCF will chose an E-CSCF that is close to the subscriber, i.e. even in a roaming scenario an E-CSCF in the visited network will enable local breakout of the voice call. Also the emergency call has to be routed properly to a Public Safety Answering Point (PSAP) in the visited network and not in the home network which might be far away from the geographic emergency location.

<IMS Registration Scenario with ICS UE (User Equipment) (Study Item in 3GPP)>

IMS Centralized Services (ICS) provide consistent services to the user regardless of the attached access type; e.g. CS domain access or IP-CAN (IP-Connectivity Access Network). For this reason enhancements to the terminal are necessary. The ICS UE is User Equipment that is capable of receiving telephony services and other services offered by IMS while the voice bearer is established via CS domain. An ICS UE can also be a UE which can access IMS via an IP-CAN that supports the full duplex speech component of the IMS multimedia telephony service. An ICS UE is not necessarily capable of VCC (Voice Call Continuity).

The most challenging scenario in ICS is the one when the terminal is attached to the CS domain and wants to receive services from the IMS. For this reason it is beneficial for the terminal to be registered in IMS in order to have the same service behavior like being PS (Packet Switched) attached.

FIG. 3 shows the basic ICS architecture for an ICS UE in the scenario of being CS attached. The new functionality in the ICS UE, the so called Local CS Access Adaptation Function (L-CAAF) allows the UE to communicate directly with the ICCF (IMS CS Control Function) in the network.

Several possibilities to support IMS registration together with IMS Centralized services have been proposed in 3GPP for this case, possible trigger to start/stop the RUA registration in the ICCF are:
Push by UE: using ICCP (IMS CS Call Control Protocol) to ICCF
Push by network: Using CAMEL (Customized Applications for Mobile Network Enhanced Logic) ph3 M-CSI (only attach/detach)
Push: new HSS functionality (attach/detach)
Pull: CAMEL ph2 ATI (Any Time Interrogation) pull to retrieve attach/detach status
Registration Timeout in ICCF
   <IMS Registration Scenario with non-ICS UE (Study Item in 3GPP)>

FIG. 4 shows the use case of S-CSCF selection in the case of ICS for a legacy terminal in the scenario of being CS attached only. Currently there are architectural options in TR 23.892 for the support of CS only terminals with IMS centralized services in the visited network by enhancing CS core network nodes like the MSC-Server. The new logical functionalities Local CS Access Adaptation Function-network equivalent (L-CAAF-n) and the IMS CS Control Function (ICCF) could be collocated with the MSC-Server or deployed as stand-alone nodes. The ICCF contains the Remote CAAF (R-CAAF) to communicate with the L-CAAF-n, a Remote User Agent (RUA).

The key issue in supporting legacy terminals, i.e. terminals that do not support special signaling directly to the ICCF is that there must be then CS network enhancements on the other hand.

In case the terminal attaches to the CS domain, it first will send e.g. a location update mobility management message. The L-CAAF-n in the MSC-Server detects this message and triggers the R-CAAF in the ICCF to initiate an IMS registration with the RUA for this subscriber. The ICCF sends out a REGISTER to the I-CSCF which forwards the REGISTER to the HLR/HSS. The HLR/HSS selects a S-CSCF for the registration and gives back the S-CSCF address to the I-CSCF who then sends the REGISTER to the S-CSCF. The S-CSCF can then download the appropriate user profile from the HLR/HSS.

### DISCLOSURE OF THE INVENTION

### Key Issues in ICS for smooth Migration Scenario

As identified in the introduction section of <<Introduction >>, the dial number translation mechanism in IMS is totally different from the one used in the CS domain. Since ICS, as hybrid architecture, provides a smooth migration scenario from CS based switching system to the full fledge IMS, it would also be important to guarantee smooth traffic changes from CS based switching system to the IMS.

Key issue 1: Routing mechanism in CS domain to be adapted to the ICS.
Key issue 2: Routing database (Translation table) can be reused/shared.

### <<Concept of Solution >>

A communication system according to an exemplary aspect of this invention is a communication system that integrates a multimedia service using an internet protocol, and allows for access via a circuit switched domain, comprising:
a serving call session controller for controlling a call session by a registered user equipment;
circuit switched access adaptation means for adding relevant information related to a location of the user equipment to a registration request of the user equipment connected to the circuit switched domain; and
controller selecting means for determining a serving call session controller for registering the user equipment based on the relevant information added to the registration request by the circuit switched access adaptation means.

A user equipment registration method according to an exemplary aspect of this invention is a user equipment registration method for registering a user equipment to a communication system that integrates a multimedia service using an internet protocol, and allows for access via a circuit switched domain, comprising:
adding relevant information related to a location of the user equipment to a registration request of the user equipment connected to the circuit switched domain and sending the request to the communication system; and
determining a serving call session controller for registering the user equipment based on the relevant information added to the registration request in the communication system.

A switching device according to an exemplary aspect of this invention is a switching device of a circuit switched domain that connects to an integrated communication system which integrates a multimedia service using an internet protocol, comprising:
switching means for performing control with the circuit switched domain related to a user equipment; and
circuit switched access adaptation means for adding relevant information related to a location of the user equipment to a registration request made to the integrated communication system of the user equipment connected to the circuit switched domain.

A user equipment registration system according to an exemplary aspect of this invention is a user equipment registration system that registers a user equipment in an integrated communication system that integrates a multimedia service using an internet protocol, comprising:
a query call session controller for making a query about a serving call session controller where the user equipment is to be registered based on a registration request of the user equipment to which relevant information is added related to a location of the user equipment connected to the circuit switched domain; and
a subscriber server for receiving the query from the query call session controller, and selecting a serving call session controller where the user equipment is to be registered among a plurality of serving call session controllers based on the relevant information.

The above and other objects, features, and advantages of the present invention will become apparent from the following description with references to the accompanying drawings which illustrate exemplary embodiments or examples of the present invention.

### BRIEF DESCRIPTION OF THE DRAWINGS

FIG. 1 shows Normal IMS Scenario;

FIG. 2 shows IMS emergency Call Scenario;

FIG. 3 shows IMS Registration Scenario with ICS UE;

FIG. 4 shows IMS Registration Scenario with non-ICS UE;

FIG. 5 shows S-CSCF assignment based on subscriber location;

FIG. 6 shows ICCF collocated with S-CSCF and P-CSCF in local area;

FIG. 7 shows ICS Scenario with S-CSCF Selection and functional entity collocation;

FIG. 8 shows IMS Registration Example with S-CSCF Selection Part 1;

FIG. 9 shows IMS Registration Example with S-CSCF Selection Part 2.

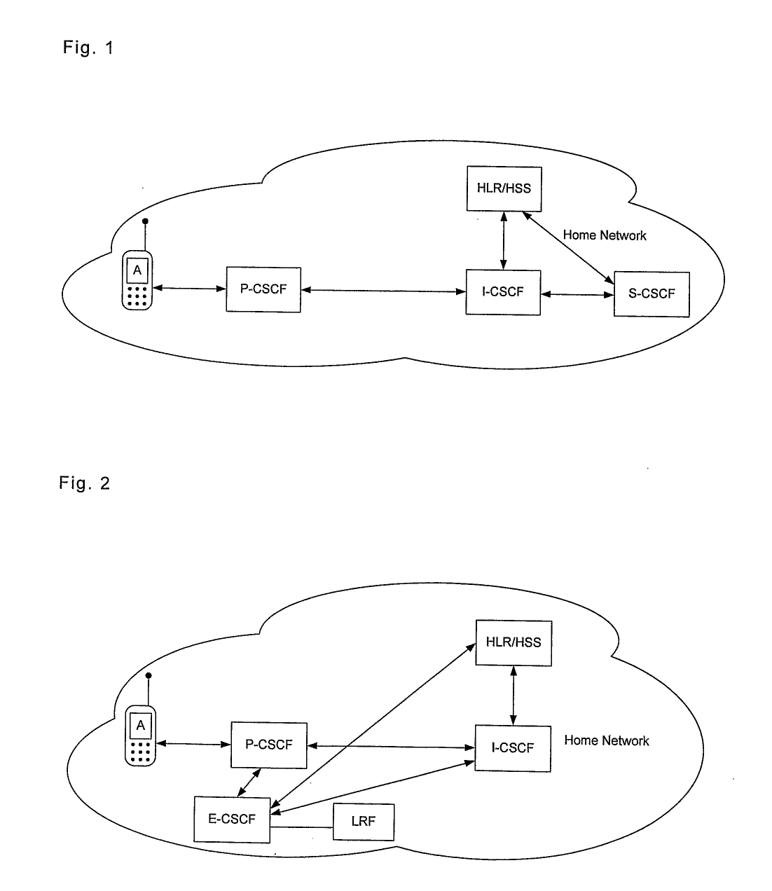

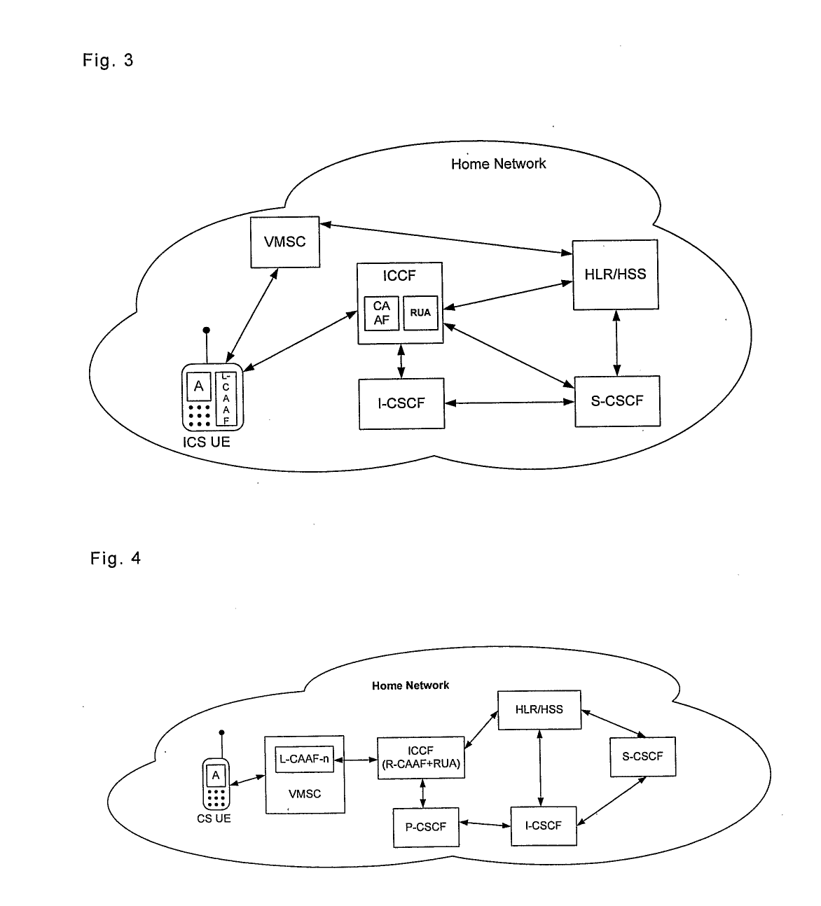

### BEST MODE FOR CARRYING OUT THE INVENTION

### <<Solution: S-CSCF Assignment Based on Subscriber Location>>

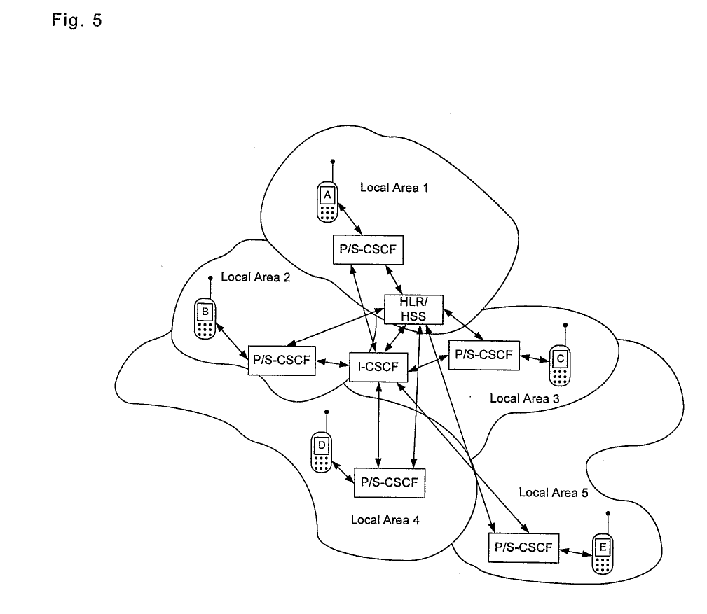

In order to provide smooth traffic change from CS domain telephony service to IMS, the best and simple way is to assign the S-CSCF in the visited local area where the V(Visited) MSC is located. Since S-CSCF can reuse the local number translation table that is used by VMSC, this approach guarantees no change of traffic. See FIG. 5.

The selection of the S-CSCF may be based on location information such as a cell identifier, GPS (Global Positioning System) information, SUPL (Secure User Plane Location) information standardized by OMA (Open Mobile Alliance) etc for a regular IMS terminal. In the case of Non ICS UE, ICCF may provide the location information on behalf of the IMS terminal.

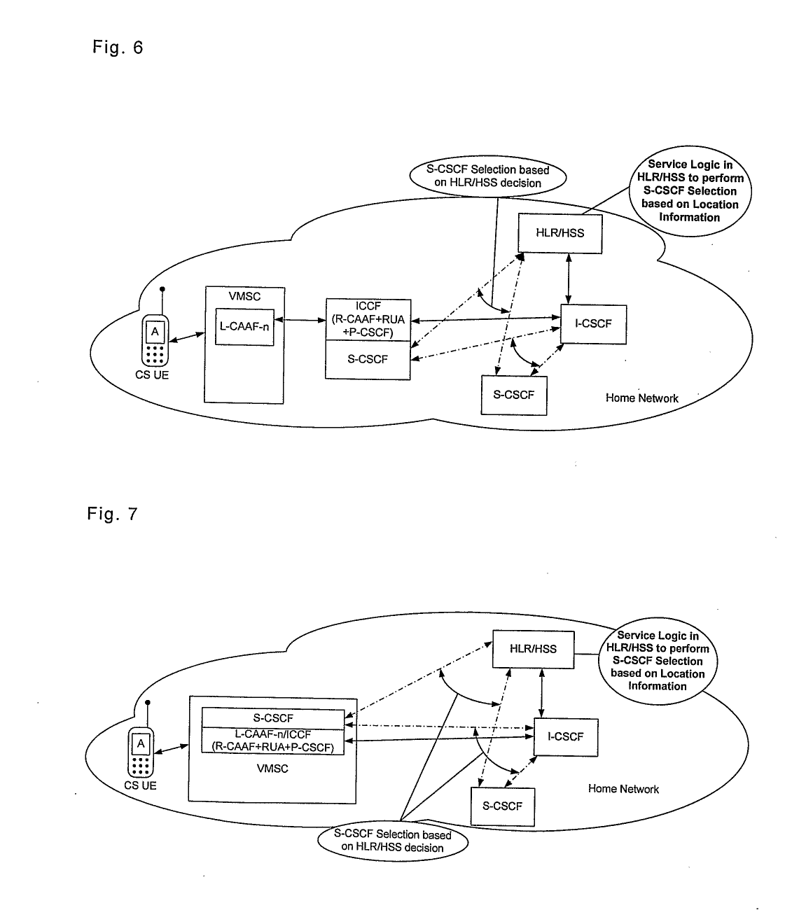

Based on this architecture, it is beneficial to collocate ICCF together with the S-CSCF and P-CSCF. Since the presence of an IP address for a User Agent is always collocated with both S-CSCF and P-CSCF, IMS call handling is significantly optimized. i.e. Interfaces between S-CSCF and P-CSCF and between S-CSCF and ICCF can be realized by an internal interface and all IMS related call processing can be done within this physical node. See FIG. 6.

In order to harmonize ICS architecture with the existing CS domain system, L-CAAF-n, ICCF and P-CSCF/S-CSCF that are collocated with the MSC-Server bring the maximum benefits.
Reuse existing local translation table→Smooth migration from CS domain to ICS
No centralized translation table for local services that 23.228 requires
No extra interfaces necessary in order to support ICS.→No CAMEL interworking between L-CAAF-n and ICCF, No ISUP (ISDN User Part) connection between VMSC and MGCF (Media Gateway Control Function)

The scenario with the collocated V-MSC-Server, ICCF and P-CSCF/S-CSCF is shown in FIG. 7.

In this case the ICCF gets triggered e.g. by the MM (Mobility Management) Location Update procedure from the CS UE, which is detected in the L-CAAF-n in the VMSC. The ICCF sends out a REGISTER to the I-CSCF in the home network. The I-CSCF queries the HSS for the best suited S-CSCF. The HSS decides based on the location data and/or subscription data to select the S-CSCF which resides in the VMSC-Server. The I-CSCF forwards the REGISTER to the S-CSCF which downloads the user profile from the HSS. Now the S-CSCF could invoke localized services for the subscriber. The solution is not limited to the above described approach but can also use other means for registration as provided in the chapter of <IMS Registration Scenario with ICS UE>.

In this registration scenario, the IMS has to know whether the subscriber is attached via either CS domain or IP-CAN in order to execute the services in the right way. To solve this problem, an indication that the subscriber is now CS attached would be sufficient.

In the case where the ICCF sends out the REGISTER, it would be beneficial to include e.g. a new P-Access-Info header like 3GPP-CS. With this new header, the HSS/HLR can detect that the contact point for the registration is the ICCF and not an IMS “real” terminal. The HSS/HLR is also able to find the right S-CSCF e.g. new access info may include the VMSC address. This information can be set by the S-CSCF for service invocation. Usually the P-Access-Info header is assumed not to be reliable as it is set by the UE, in this case the header is set by the own node of the operator network and therefore can be considered reliable.

### <<Proposed Concepts >>

Proposed concepts are included in methods of providing local services by selecting an S-CSCF that is located in the local area where the subscriber is located. The methods contain followings.
1. Based on subscriber location, S-CSCF is assigned to a local area where local number translation is possible the same manor with the CS domain telephony service.
2. The selection of the S-CSCF may be based on location information such as a cell identifier, GPS information, SUPL information standardized by OMA etc for regular IMS terminal.
3. For dual radio UE which has a capability for communicating using both CS domain and other IP based access systems and which also has a capability to continue services between two domains, it provides high quality of hand over performance, i.e. low latency, by assigning S-CSCF in a local area since heterogeneous system hand over can be anchored in the local network.
4. In the case of Non ICS UE, ICCF may provide the location information on behalf of the IMS terminal.
5. Marking the SIP (Session Initiation Protocol) REGISTER with a new P-Access-Info Header called e.g. access type=3GPP-CS to indicate that the UE is IMS registering over CS access
6. Marking the SIP REGISTER with a new P-Access-Info Header called e.g. access info=MSC address to indicate the S-CSCF to be chosen by the IMS.
7. Conveying the access type and access info information to HSS over the Cx interface (Between CSCF and HSS) in order for HSS to make an S-CSCF selection.
8. ICCS is co-located with the S-CSCF and P-CSCF as the network optimization.
9. L-CAAF-n, ICCF and P-CSCF/S-CSCF are collocated with the MSC in order to harmonize ICS architecture with existing CS domain system.
10. In case S-CSCF is collocated with the MSC in the visited network, there are two ways to convey subscriber data information to the S-CSCF:
   Define the Cx interface, between HSS and CSCF, as the external interface between operators. Note that the Cx interface is an internal interface within the operator network. In this case,
   Generate subscriber information in S-CSCF by interrogating the MSC/VLR (Visitor Location Resister). Note that VLR has subscriber information gotten over the D interface.
11. The MSC database for local number translation can be reused for IMS Service.

### <<Annex >>

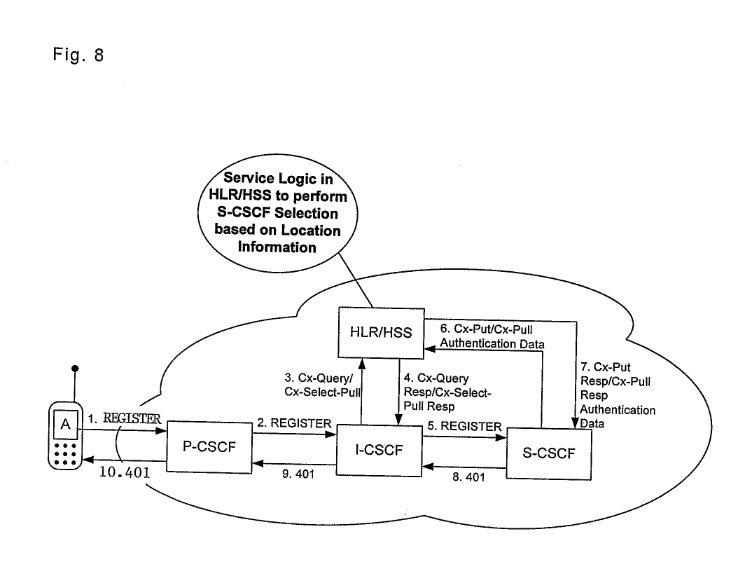

FIG. 8 shows the IMS Registration flow example and when the new service logic shall apply the S-CSCF selection.
1. The UE sends a REGISTER to the P-CSCF
2. The P-CSCF determines the I-CSCF and forwards the REGISTER
3. The I-CSCF sends a Cx-Query/Cx-Select-Pull to the HLR/HSS to get the S-CSCF address
4. The HLR/HSS executes a special service logic which selects the S-CSCF based on geographic location information sent from the UE such as global cell ID, SUPL, GPS measurements and the HLR/HSS selects a geographically close located S-CSCF. The S-CSCF address is send to the I-CSCF within the Cx-Query Response/Cx-Select-Response message.
5. The I-CSCF now knows the S-CSCF address and forwards the REGISTER to the S-CSCF
6. The S-CSCF checks the authentication status of the subscriber. If the S-CSCF does not have a corresponding user profile, it queries the HLR/HSS with a Cx-Put/Cx-Pull of the authentication data.
7. The HSS sends the authentication data to the S-CSCF within the Cx-Put/Cx-Pull response
8. The S-CSCF sends the challenge in a 401 (Unauthorized) response to the I-CSCF
9. The I-CSCF forwards the 401 to the P-CSCF
10. The P-CSCF finally forwards the 401 message to the UE

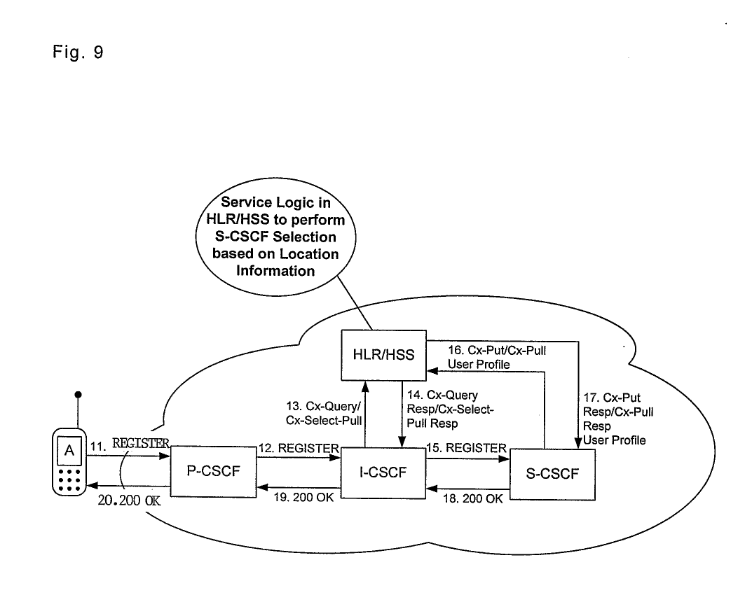

FIG. 9 shows the call flow after the UE calculated the response to the received challenge in the previous figure.
11. The UE sends the response in a new REGISTER to the P-CSCF
12. The P-CSCF determines the I-CSCF and forwards the REGISTER there
13. The I-CSCF sends a Cx-Query/Cx-Select-Pull to the HLR/HSS to get the S-CSCF address
14. The HLR/HSS executes a special service logic which selects the S-CSCF based on geographic location information send from the UE such as global cell ID, SUPL, GPS measurements, and the HLR/HSS selects a geographically close located S-CSCF. The S-CSCF address is send to the I-CSCF within the Cx-Query Response/Cx-Select-Response message.
15. The I-CSCF now knows the S-CSCF address and forwards the REGISTER to the S-CSCF
16. The S-CSCF checks the authentication data. If the response fits the challenge, the S-CSCF downloads the user profile from the HSS/HLR, i.e. it queries the HLR/HSS with a Cx-Put/Cx-Pull of the user profile.
17. The HSS sends the user profile to the S-CSCF within the Cx-Put/Cx-Pull response
18. The registration is complete and the S-CSCF sends 200 OK to the 1-CSCF
19. The I-CSCF forwards the 200 OK to the P-CSCF
20. The P-CSCF forwards the 200 OK message finally to the UE

While exemplary embodiments of the present invention have been described using specific terms, such description is for illustrative purposes only, and it is to be understood that changes and variations may be made without departing from the spirit or scope of the following claims.

The above mentioned exemplary embodiments may be organized into following examples.

Example 1 is a communication system that integrates a multimedia service using an internet protocol, and allows for access via a circuit switched domain, comprising:
a serving call session controller (corresponding to an S-CSCF) for controlling a call session by a registered user equipment;
circuit switched access adaptation means (corresponding to a CAAF) for adding relevant information related to a location of the user equipment to a registration request of the user equipment connected to the circuit switched domain; and
a controller selecting device (corresponding to an I-CSCF and an HSS) for determining a serving call session controller for registering the user equipment based on the relevant information added to the registration request by the circuit switched access adaptation device.

Example 2 is the communication system according to example 1, wherein
the circuit switched access adaptation device is located in a switching device of the circuit switched domain, and
the switching device including the circuit switched access adaptation device sends the registration request.

Example 3 is the communication system according to example 1 or 2, wherein the relevant information added to the registration request includes information related to the switching device of the circuit switched domain to which the user equipment is connected.

Example 4 is the communication system according to example 3, wherein the relevant information added to the registration request includes an access-info header indicating a serving call session controller where the user equipment is to be registered.

Example 5 is the communication system according to example 4, wherein the access-info header includes access-info indicating the address of the switching device of the circuit switched domain to which the user equipment is connected.

Example 6 is the communication system according to any one of examples 3 to 5, wherein the relevant information added to the registration request includes an access-info header indicating a registration of the user equipment via the circuit switched domain.

Example 7 is the communication system according to example 6, wherein the access-info header includes an access type indicating Third Generation Partnership Project circuit switching.

Example 8 is the communication system according to any one of examples 3 to 7, wherein the registration request is a register message of a Session Initiation Protocol.

Example 9 is the communication system according to any one of examples 1 to 8, wherein the controller selecting device selects a serving call session controller geographically close to the user equipment as a registration destination of the user equipment.

Example 10 is the communication system according to any one of examples 1 to 9, wherein
the serving call session controller comprises a function for handling a local service in a predetermined local area, and

the controller selecting device selects a serving call session controller that handles a local service in a local area where the user equipment is located.

Example 11 is the communication system according to any one of examples 1 to 10, wherein
the controller selecting device comprises:
a query call session controller (corresponding to an I-CSCF) for making a query about a serving call session controller where the user equipment is to be registered based on the registration request; and
a subscriber server (corresponding to an HSS) for accepting the query from the query call session controller, selecting a serving call session controller where the user equipment is to be registered from among a plurality of serving call session controllers, and sending a notification to the query call session controller.

Example 12 is the communication system according to example 11, wherein
the query call session controller sends the registration request to the serving call session controller which receives the notification from the subscriber server, and
the serving call session controller obtains subscription information for the user equipment from the subscriber server.

Example 13 is the communication system according to example 12, which uses a Cx interface between the serving call session controller and the subscriber server to send the subscription information for the user equipment to the serving call session controller from the subscriber server.

Example 14 is the communication system according to any one of examples 11 to 13, wherein the query call session controller sends information about an access from the user equipment over the Cx interface between the query call session controller and the subscriber server in order to select the serving call session controller.

Example 15 is a user equipment registration method for registering a user equipment to a communication system that integrates a multimedia service using an internet protocol, and allows for access via a circuit switched domain, comprising:
adding relevant information related to a location of the user equipment to a registration request of the user equipment connected to the circuit switched domain and sending the request to the communication system; and
determining a serving call session controller for registering the user equipment based on the relevant information added to the registration request in the communication system.

Example 16 is the user equipment registration method according to example 15, wherein
a circuit switched access adaptation device located in a switching device of the circuit switched domain adds relevant information related to a location of the user equipment to a registration request of the user equipment; and
the switching device including the circuit switched access adaptation device sends the registration request to the communication system.

Example 17 is the user equipment registration method according to example 15 or 16, wherein the relevant information added to the registration request includes information related to the switching device of the circuit switched domain to which the user equipment is connected.

Example 18 is a switching device of a circuit switched domain that connects to an integrated communication system which integrates a multimedia service using an internet protocol, comprising:
a switching device for performing control with the circuit switched domain related to a user equipment; and
a circuit switched access adaptation device for adding relevant information related to a location of the user equipment to a registration request to the integrated communication system of the user equipment connected to the circuit switched domain.

Example 19 is the switching device according to example 18, wherein the relevant information added to the registration request includes information related to the switching device of the circuit switched domain to which the user equipment is connected.

Example 20 is a user equipment registration system that registers a user equipment in an integrated communication system that integrates a multimedia service using an internet protocol, comprising:
a query call session controller for querying about a serving call session controller where the user equipment is to be registered based on a registration request of the user equipment to which relevant information is added related to a location of the user equipment connected to the circuit switched domain; and
a subscriber server for receiving the query from the query call session controller, and selecting a serving call session controller where the user equipment is to be registered among a plurality of serving call session controllers based on the relevant information.

Example 21 is a communication system for performing IP multimedia subsystem (IMS) registration, the communication system comprising:
a mobile switching center (MSC) server;
an interrogating call session control function (I-CSCF) apparatus in an IP multimedia subsystem (IMS);
a home subscriber server (HSS) in the IMS; and
a serving call session control function (S-CSCF) apparatus in the IMS,
wherein the MSC server sends a register to the IMS, and the register includes information about the MSC server.

Example 22 is the communication system according to claim 21, wherein the register is a session initiation protocol (SIP) register.

Example 23 is the communication system according to claim 21, wherein the MSC server sends the register to the I-CSCF in the IMS.

Example 24 is a switching apparatus for use in a communication system that performs IP multimedia subsystem (IMS) registration and comprises an IP multimedia subsystem (IMS) including an interrogating call session control function (I-CSCF), a home subscriber server (HSS), and a serving call session control function (S-CSCF),
wherein the switching apparatus sends a register to the IMS, and the register includes information about the switching apparatus.

Example 25 is the switching apparatus according to claim 24, wherein the switching apparatus is a mobile switching center (MSC) server.

Example 26 is the switching apparatus according to claim 24, wherein the register is a session initiation protocol (SIP) register.

Example 27 is the switching apparatus according to claim 24, wherein the switching apparatus sends the register to the I-CSCF in the IMS.

Example 28 is an IP multimedia subsystem (IMS) registration method used in a communication system which includes a switching apparatus, an interrogating call session control function (I-CSCF) apparatus, a home subscriber server (HSS) and a serving call session control function (S-CSCF) apparatus, comprising:
sending a register from the switching apparatus to the IMS, and the register includes information about the switching apparatus.

Example 29 is the IMS registration method according to claim 28, wherein the switching apparatus is a mobile switching center (MSC) server.

Example 30 is the IMS registration method according to claim 28, wherein the register is a session initiation protocol (SIP) register.

Example 31 is the IMS registration method according to claim 28, wherein the switching apparatus sends the register to the I-CSCF in the IMS.

This application is based upon and claims the benefit of priority from Japanese Patent Application No. 2007-196735 filed in Japan Patent Office on Jul. 27, 2007, the contents of which are hereby incorporated by reference.

1-14. (canceled)

15. A user equipment registration method for registering a user equipment to a communication system that integrates a multimedia service using an internet protocol, and allows for access via a circuit switched domain, comprising:
adding relevant information related to a location of the user equipment to a registration request of the user equipment connected to the circuit switched domain and sending the request to the communication system; and
determining a serving call session controller that register the user equipment based on the relevant information added to the registration request in the communication system.

16. The user equipment registration method according to claim 15, wherein
a circuit switched access adaptation unit located in a switching device of the circuit switched domain adds relevant information related to a location of the user equipment to a registration request of the user equipment; and
the switching device including the circuit switched access adaptation unit sends the registration request to the communication system.

17. The user equipment registration method according to claim 15, wherein the relevant information added to the registration request includes information related to the switching device of the circuit switched domain to which the user equipment is connected.

18. (canceled)

19. (canceled)

20. A user equipment registration system that registers a user equipment in an integrated communication system that integrates a multimedia service using an internet protocol, comprising:
a query call session controller that makes a query about a serving call session controller where the user equipment is to be registered based on a registration request of the user equipment to which relevant information is added related to a location of the user equipment connected to the circuit switched domain; and
a subscriber server that receives the query from the query call session controller, and selects a serving call session controller where the user equipment is to be registered from among a plurality of serving call session controllers based on the relevant information.

21. A communication system that performs IP multimedia subsystem (IMS) registration, the communication system comprising:
a mobile switching center (MSC) server;
an interrogating call session control function (I-CSCF) apparatus in an IP multimedia subsystem (IMS);
a home subscriber server (HSS) in the IMS; and
a serving call session control function (S-CSCF) apparatus in the IMS,
wherein the MSC server sends a register to the IMS, and the register includes information about the MSC server.

22. The communication system according to claim 21, wherein the register is a session initiation protocol (SIP) register.

23. The communication system according to claim 21, wherein the MSC server sends the register to the I-CSCF in the IMS.

24. A switching apparatus for use in a communication system that performs IP multimedia subsystem (IMS) registration and comprises an IP multimedia subsystem (IMS) including an interrogating call session control function (I-CSCF), a home subscriber server (HSS), and a serving call session control function (S-CSCF),
wherein the switching apparatus sends a register to the IMS, and the register includes information about the switching apparatus.

25. The switching apparatus according to claim 24, wherein the switching apparatus is a mobile switching center (MSC) server.

26. The switching apparatus according to claim 24, wherein the register is a session initiation protocol (SIP) register.

27. The switching apparatus according to claim 24, wherein the switching apparatus sends the register to the I-CSCF in the IMS.

28. An IP multimedia subsystem (IMS) registration method used in a communication system which includes a switching apparatus, an interrogating call session control function (I-CSCF) apparatus, a home subscriber server (HSS) and a serving call session control function (S-CSCF) apparatus, comprising:
sending a register from the switching apparatus to the IMS, and the register includes information about the switching apparatus.

29. The IMS registration method according to claim 28, wherein the switching apparatus is a mobile switching center (MSC) server.

30. The IMS registration method according to claim 28, wherein the register is a session initiation protocol (SIP) register.

31. The IMS registration method according to claim 28, wherein the switching apparatus sends the register to the I-CSCF in the IMS.

32. The user equipment registration method according to claim 16, wherein the relevant information added to the registration request includes information related to the switching device of the circuit switched domain to which the user equipment is connected.
